(19) United States
(12) Patent Application Publication
(10) Pub. No.: US 2002/0198904 A1
(43) Pub. Date: Dec. 26, 2002

(54) Document production in a distributed environment

(76) Inventors: Rogelio Robles, San Diego, CA (US); Hector Rodriguez-Aviles, Bugambilias Guadalajara Jalisco (MX)

Correspondence Address: HEWLETT-PACKARD COMPANY, Intellectual Property Administration, P.O. Box 272400, Fort Collins, CO, 80527-2400, US

(21) Appl. No.: 09/887,306

(22) Filed: Jun. 22, 2001

(51) Int. Cl. G06F 17/24; G06F 17/21; G06F 17/00; G06F 15/00

(52) U.S. Cl. 707/500

(57) ABSTRACT

A method for managing document production over a computer network. It is envisioned that the method will be implemented in a computer program product distributed across two or more computing devices. The product includes computer readable instructions for capturing a document production request and generating a user interface having user accessible controls for associating selected services and related options with the production request. The product merges the production request, the selected services, and related options into a production plan and delivers that plan to one or more selected document production devices. In varying embodiments, the product also generates user interfaces for choosing production devices for providing the selected services and for managing production plans.

### FIELD OF THE INVENTION

The present invention is directed to a method and system for electronic document production. More particularly, the invention is directed to a method and system for document production in a distributed environment.

### BACKGROUND OF THE INVENTION

In a basic desktop computing environment, a printer or other document production device is connected directly to a computer. To produce a document, a user either opens or creates an electronic document using a word processor or other application. The user then issues a production request. A driver, specific to the selected production device—a printer in this example generates a user interface allowing the user to select options for formatting the document. Among others, these options can include the number of copies, print resolution, specific paper source and output bins. With the desired options selected, the driver formats the production request into a specialized series of commands directing the printer to produce the document on one or more sheets of paper. To add a new production device, the user simply connects the new device and installs the new driver for that device on the computer. With only one or two production devices available, the user can easily become familiar and comfortable with the user interface and available options for each.

In a more complex environment, the computer and production devices are components of a larger network of electronic devices. While new printers and other production devices can be easily connected to the network, drivers for those devices must be individually installed on each client computer that accesses the new device. As updates for the device drivers become available, the updates must also be installed on each client computer. With the exception perhaps of the network administrator, users on even a relatively small network may not be familiar or even aware of available production services. A user may desire to print a color document, but not know that color production is an available service. Even if a user is aware of a particular device, that user may not be familiar or comfortable with the user interface generated by the driver for the device.

### SUMMARY OF THE INVENTION

The present invention is directed to a method for managing document production over a computer network. It is envisioned that the method will be implemented in a computer program product distributed across two or more computing devices. The product includes computer readable instructions for capturing a document production request and generating a user interface having user accessible controls for associating selected services and related options with the production request. The product merges the production request, the selected services, and related options into a production plan and delivers that plan to one or more selected document production devices. In varying embodiments, the product also generates user interfaces for choosing production devices for providing the selected services and for managing production plans.

### DESCRIPTION OF THE DRAWINGS

FIG. 1 is a schematic representation of a computer network that includes several client computers, a server, and several document production devices

FIG. 2 is a block diagram of the network of FIG. 1 in which the invented document production system is embodied in software running on the server and a client computer according to one embodiment of the present invention.

FIG. 3 is a block diagram illustrating the logical components of a production plan generated by the production server of FIG. 2.

FIG. 4 is a block diagram further illustrating the logical components of the production server according to one embodiment of the present invention.

FIG. 5 is a block diagram further illustrating the logical components of the production client.

FIG. 6 is a block diagram in which components of the production server are located on separate computing devices according to another embodiment of the present invention.

FIG. 7 is a block diagram in which the production server includes multiple production engines located on separate computing devices according to another embodiment of the present invention.

FIG. 8 is a block diagram in which a production engine is incorporated into each production device according to another embodiment of the present invention.

FIG. 9 is a block diagram in which the components of the services database are located on separate computing devices according to another embodiment of the present invention.

FIG. 10 is a flow diagram illustrating the document production process according to one embodiment of the present invention.

FIGS. 11A and 11B are exemplary screen views illustrating the initiation of the document production process.

FIGS. 12A-12F are exemplary screen views of a service selection interface according to one embodiment of the present invention.

FIG. 13 is an exemplary screen view of a device selection interface according to one embodiment of the present invention.

FIG. 14 is an exemplary screen view of a production management interface according to one embodiment of the present invention.

### DETAILED DESCRIPTION OF THE INVENTION

In a computer network environment, a user may produce a document using any number of available services provided by a laser printer, finishing device (binder, collator, folder), facsimile machine, and/or other document production devices. Generally, for each service, the user is presented with multiple options such as duplex for a printing service or spiral bind for a finishing service. By providing a common user interface that focuses on how the document is to be produced rather than the particular device providing the service, the invented document production system allows a person to produce an electronic document on a computer network with limited knowledge of the services and options available. Moreover, the system provides centralized management of the drivers for the network's production services making the addition of new services to the network more efficient.

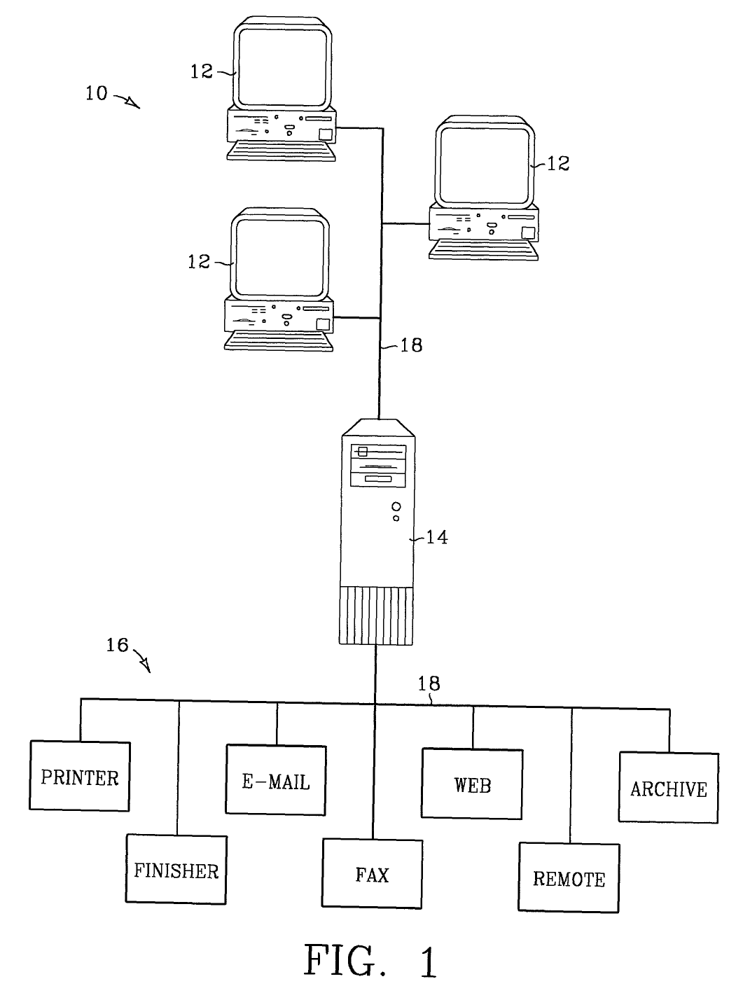

Although the various embodiments of the invention disclosed herein will be described with reference to the computer network 10 shown schematically in FIG. 1, the invention is not limited to use with network 10. The invention may be implemented in or used with any computer system in which it is necessary or desirable to physically or electronically produce electronic documents. The following description and the drawings illustrate only a few exemplary embodiments of the invention. Other embodiments, forms, and details may be made without departing from the spirit and scope of the invention, which is expressed in the claims that follow this description.

Referring to FIG. 1, network 10 represents generally any local or wide area network in which a variety of different electronic devices are linked. Network 10 includes one or more client computers 12, typically personal computer workstations, a server 14, and production devices 16. Communication link 18 interconnects client computers 12, server 14, and production devices 16. The production devices 16 illustrated include a printer, a finisher such as a binder, sorter, or folder, an e-mail client, a facsimile device, an internet server, a remote server connected to other production devices, and an archive or electronic data storage device. Production devices are not limited to those illustrated but may include any device capable of electronically or physically saving, displaying, formatting, or transferring an electronic document.

Communication link 18 represents generally a cable, wireless, or remote connection via a telecommunication link, an infrared link, a radio frequency link, or any other connector or system that provides electronic communication between the network devices. Communication link 18 may represent an intranet, an internet, or a combination of both. The path followed by link 18 between network devices 12, 14, and 16 in the schematic view of FIG. 1 represents the logical communication path between these devices, not necessarily the physical path between the devices. That is to say, for example, that server 14 need not be physically interposed between client computers 12 and production devices 16. Rather, network devices can be connected to the network at any point and the appropriate communication path established logically between the devices which, in this example, would be from client computer 12 to server 14 and then to the respective production devices 16.

### COMPONENTS

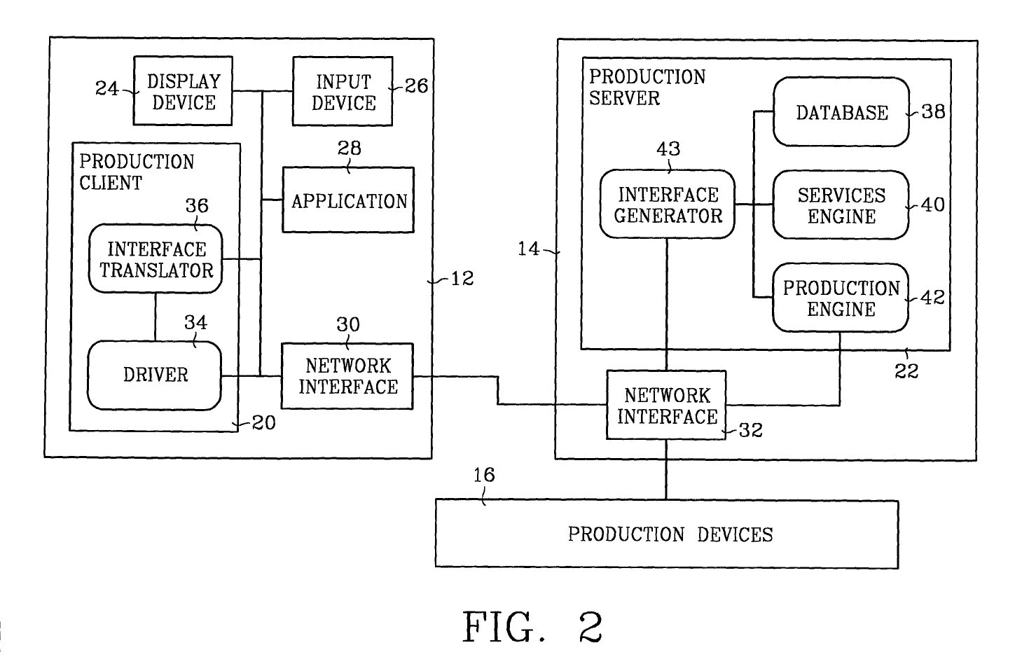

The logical components of one embodiment of the invented document production system will now be described with reference to the block diagrams of FIGS. 2-5. In FIG. 2, the invention is embodied in software, described in more detail below, labeled as production client 20 operating on client computer 12 and production server 22 operating on server 14. Client computer 12 provides a mechanism for the user to create and save electronic documents and issue production requests for those electronic documents. Each client computer 12 generally includes a monitor or other suitable display device 24 and a keyboard and/or a pointing device such as a mouse or other suitable input device 26. Application 28 may be a word processor, graphic editor, and/or any other computer program product capable of issuing a production request for a selected document. Network interface 28 enables client computer 12 to communicate with server 14. Similarly, server 14 includes network interface 32 enabling server 14 to communicate with client computer 12.

Production client 20, responsible for directing production requests and other user commands to server 14, generally includes capture driver 34 and interface translator 36. Capture driver 34 receives production requests from application 28 not unlike a device driver for a printer or other production device. However, instead of delivering the request to a production device, capture driver 34 delivers the request to production server 22. It is envisioned that capture driver 34 will also translate the request into a generic or non-device-specific format such as a PDL (page description language) file. An Adobe® PDF (portable document format) or a postscript file are just two examples. Interface translator 36 is responsible for causing display device 24 to display a desired user interface and for delivering instructions to production server 22.

Production server 22 administers the production requests and generally includes services database 38, services engine 40, production engine 42, and interface generator 43. Interface generator 43 directs interface translator 36 to display a user interface having user accessible controls for selecting services and service options for producing the document production requests. The controls displayed can take many forms. They may be pushbuttons, radio buttons, text boxes, scroll bars, or pull-down menus accessible using a keyboard and/or a pointing device such as a mouse connected to client computer 12. In a non-graphical environment, the controls may be command lines allowing the user to enter textual commands using a keyboard connected to client computer 12.

It is envisioned that interface generator 43 will be a web server and that interface translator 36 will be a web browser. Using HTML (hyper-text mark up language) and/or another internet language, web server 43 creates a user interface in the form of a web page accessed and displayed by web browser 36. Beneficially, this allows cross platform communication. For example, client computer 12 may be running one operating system such as Microsoft® Windows® while server 14 may be running Unix®. Generally, many client computers 12 will already include a browser capable of at least partially performing as an interface translator. In such case, production client 20, in addition to capture driver 34 will include a browser extension that will act as an interface between the web content executing in the browser, capture driver 34, and application 28 or other source or sources of the electronic document being produced.

Services engine 40 provides interface generator 43 with information concerning production services and related options. For physical document production, services can include printing and finishing. Print service options can include settings related to speed, resolution, paper source, and output bins. Finishing service options can include settings related to binding type (spiral, staple, adhesive), collating, or folding. For electronic document production, services can include electronic mail delivery, facsimile service, web publication, and electronic storage. Options for a facsimile service, for example, can include settings related to identifying a recipient and producing a cover sheet. Options for an electronic mail service, can include settings related to identifying a recipient, linking attachments, and incorporating a subject line. Services engine 40 is also responsible for identifying a document production device or devices for providing the selected services and service options.

Services database 38 provides electronic storage containing data representing services and service options available on the particular network 10 or elsewhere. Database 38 may also contain instructions for generating user accessible controls pertaining to each service as well as the name or other location identifier of each device capable of providing each service. While it is envisioned that services engine 40 will retrieve information on available services form database 38, services engine 40, may instead retrieve that information directly from production devices 16 using SNMP (Simple Network management Protocol) for example.

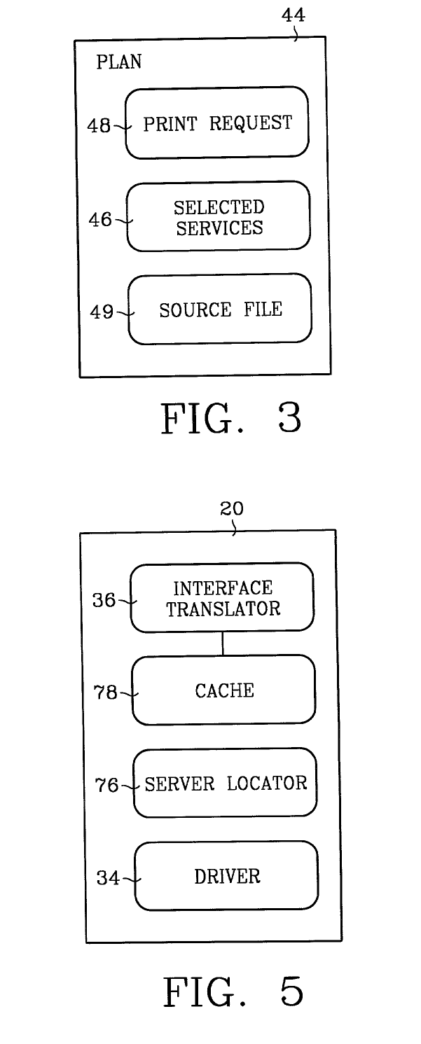

Production engine 42 is responsible for directing one or more selected devices 16 to produce the document. Production engine 42 generates a document production plan 44 (shown in FIG. 3) by merging the selected services and service options 46 with production request 48 captured by production client 20. Production plan 44 may also include the electronic source file 49 for the particular document. Referring back to FIG. 2, production engine 42 then delivers production plan 44 to the appropriate production device or devices 16.

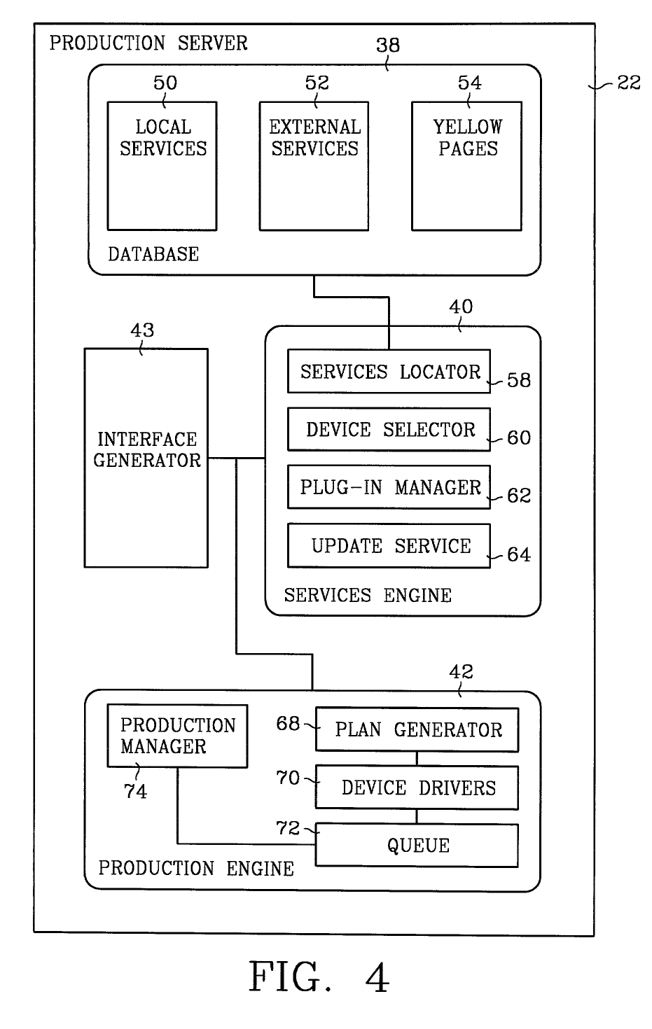

FIG. 4 provides a more detailed illustration of production server 22. In the embodiment illustrated, services database 38 includes information on local services 50, external services 52, and a services directory or yellow pages 54. Local services 50 include those services known to exist on network 10. External services contain those services known to exist on another network. Yellow pages 54 contain a listing of potentially every available service and, if known, the location of a device capable providing each service. For example, yellow pages 54 may contain information on production devices and services available at a commercial printer. Yellow pages 54 may also contain information on devices generally available on the market.

Services engine 40 includes services locator 58, device selector 60, plug-in manager 62, and update service 64. Services locator 58, communicates with services database 38 and provides interface generator 43 with the information needed to generate a user interface with user accessible controls for selecting services and related options. Once interface translator 36 transmits a user's selection of services and related options back to services engine 40, device selector 60 queries services database 38 or devices 16 directly and identifies a device or devices 16 capable of providing the selected services. Interface generator 43, then, generates a user interface with user accessible controls for selecting between the identified device or devices. Plug-in manger 62 represents generally any programming capable of managing updates to the document production system. Update service 64 communicates with network 10, using SNMP (Simple Network Management Protocol) for example, and identifies document production devices 16 providing services not reflected in services database 38. Update service 64 then updates database 38 with information concerning the identified services and related options.

Production engine 42 includes plan generator 68, device drivers 70, and queue 72. Plan generator 68 is responsible for merging formatted production request 44 with selected services 46, as illustrated in FIG. 3. Device drivers 70 translate the production plan 44 into a specialized set of commands for each selected production device 16 handling production plan 44. Beneficially, when a new production device is added to network 10, the drivers for that device need only be installed on server 14 updating production engine 42. It is envisioned that update service 64 will also identify new devices connected to network 10 and update device drivers 70 with drivers for the newly identified services.

Production devices such as printers are capable of producing one production plan at a time and occasionally malfunction. Queue 72 is an electronic holding bin allowing production engine 42 to manage production plans 44 directed to a busy or malfunctioning device. Production manager 74 administers the production plans 44 within queue 72. Production manager 74 tracks the status of each production plan 44 and provides interface generator 43 with the information required to generate a user interface for displaying the status of each production plan 44 as well as user accessible controls for directing how production manager 74 manipulates the production plans 44 held within queue 34.

FIG. 5 provides a more detailed illustration of production client 20. In addition to interface translator 36 and capture driver 34, production client 20 includes production server locator 76 and cache 78. Server locator 76, using SNMP for example, communicates over network 10 and identifies the IP (Internet Protocol) address or other identifier of production server 22. A TCP (transmission control protocol) communication link, for example, is then established between production client 20 and production server 22. Cache 78 may store information such as a user name and password allowing a particular user access to the system as well as other preferences for the user such as information on preferred document production devices.

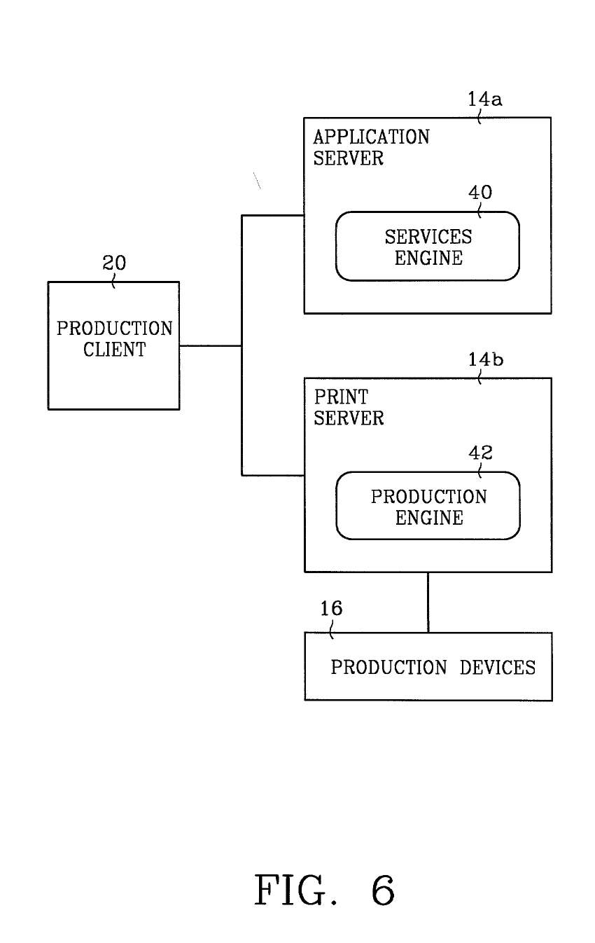

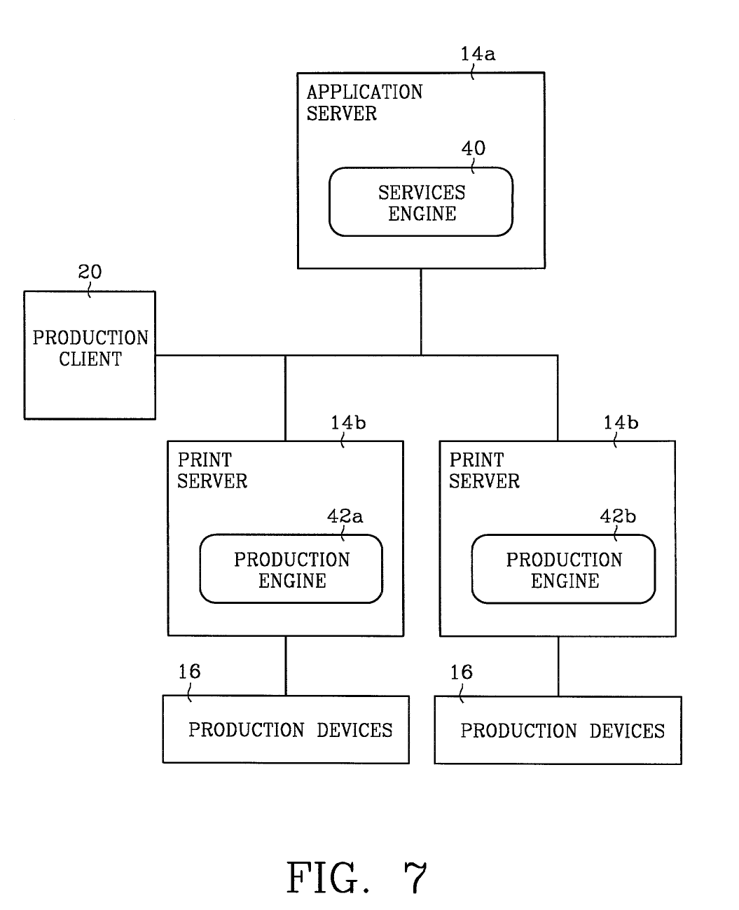

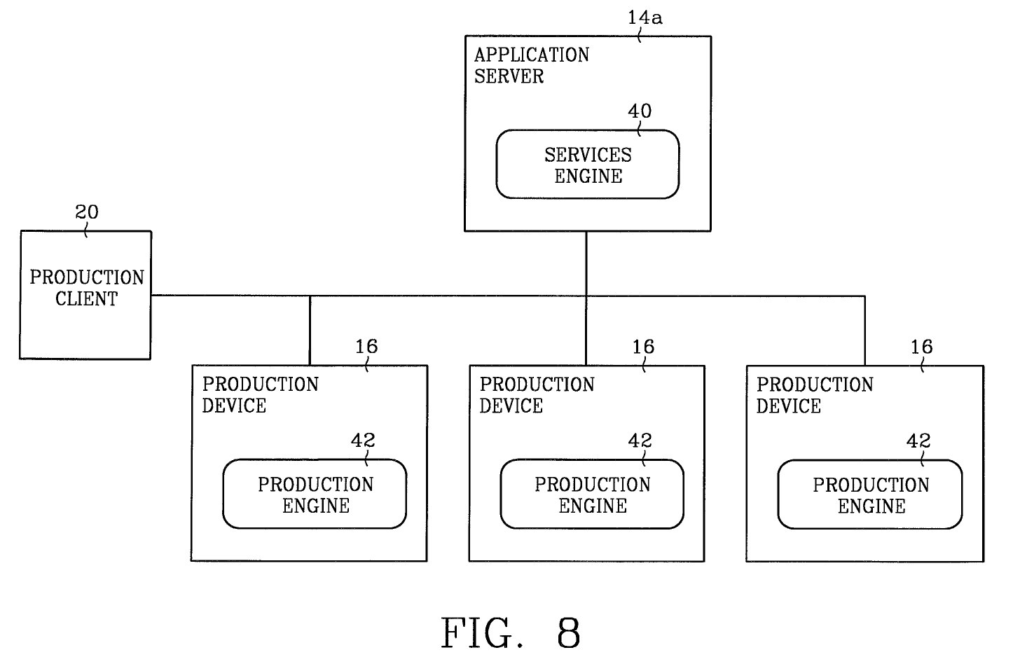

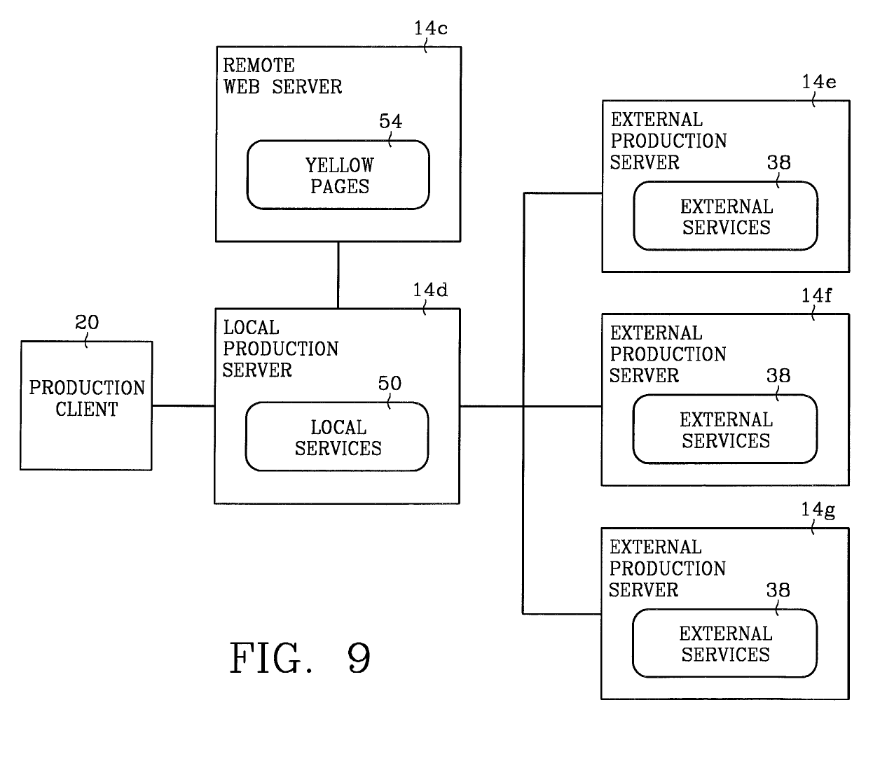

The above description provides only one example of the implementation of the invention. In other embodiments, services engine 40 and production engine 42 may be located on separate computing devices such as an application server 14A and a print server 14B (FIG. 6). Separate production engines 42A and 42B may each control a distinct group of devices 16 (FIG. 7). A production engine 42 may be incorporated directly into one or more production devices 16 (FIG. 8). Services database 38 need not be located on server 14. Database 38 may be located on a remote server. In the embodiment shown in FIG. 9, the local services 50 portion of database 38 may located on local server 14, while the yellow pages 54 portion is located on remote web server 14C providing a continually updated listing of services and related options. The external services 52 portion of database 38 may then be located on or more different production servers operating on external servers 14E, 14F, and 14G.

Although it is envisioned that the invented document production system will be embodied in software as discussed above, as an alternative it may also be embodied in hardware or a combination of software and hardware. If embodied in hardware, the document production system can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The block diagrams of FIGS. 1-9 show the architecture, functionality, and operation of an implementation of the document production system. If embodied in software, each block may represent a module, segment, or portion of code that comprises one or more executable instructions to implement the specified logical function(s). If embodied in hardware, each block may represent a circuit or a number of interconnected circuits to implement the specified logical function(s).

Also, the document production system can be embodied in any computer-readable medium for use by or in connection with an instruction execution system such as a computer/processor based system or other system that can fetch or obtain the logic from the computer-readable medium and execute the instructions contained therein. In the context of this document, a “computer-readable medium” can be any medium that can contain, store, or maintain the document production system for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc.

### USE

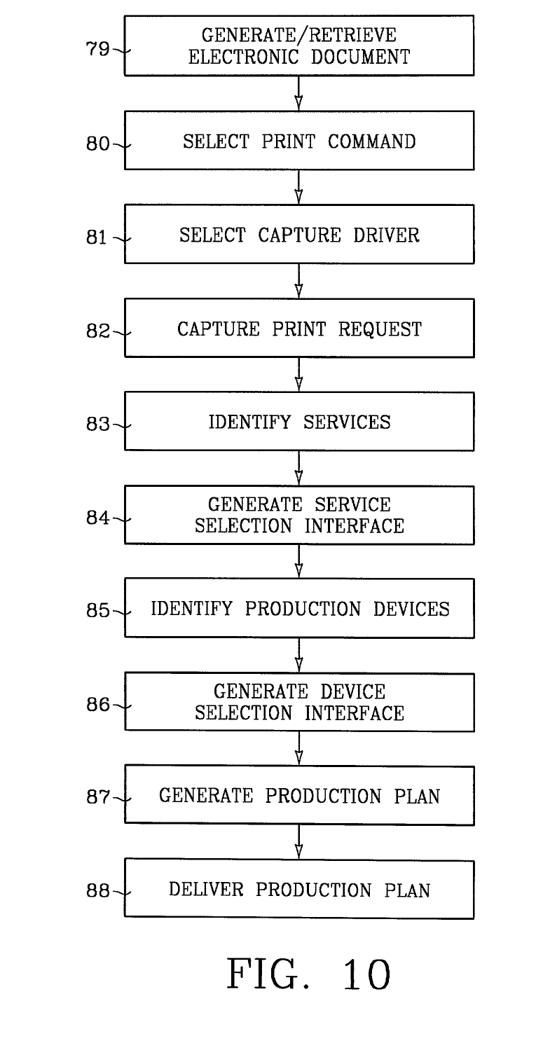

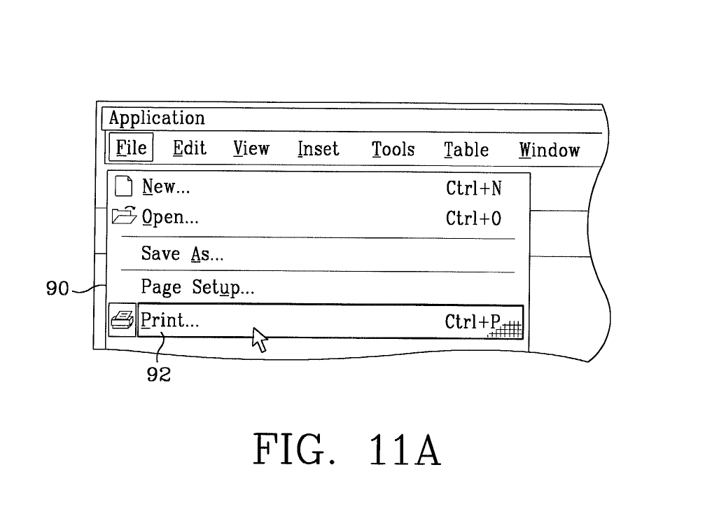

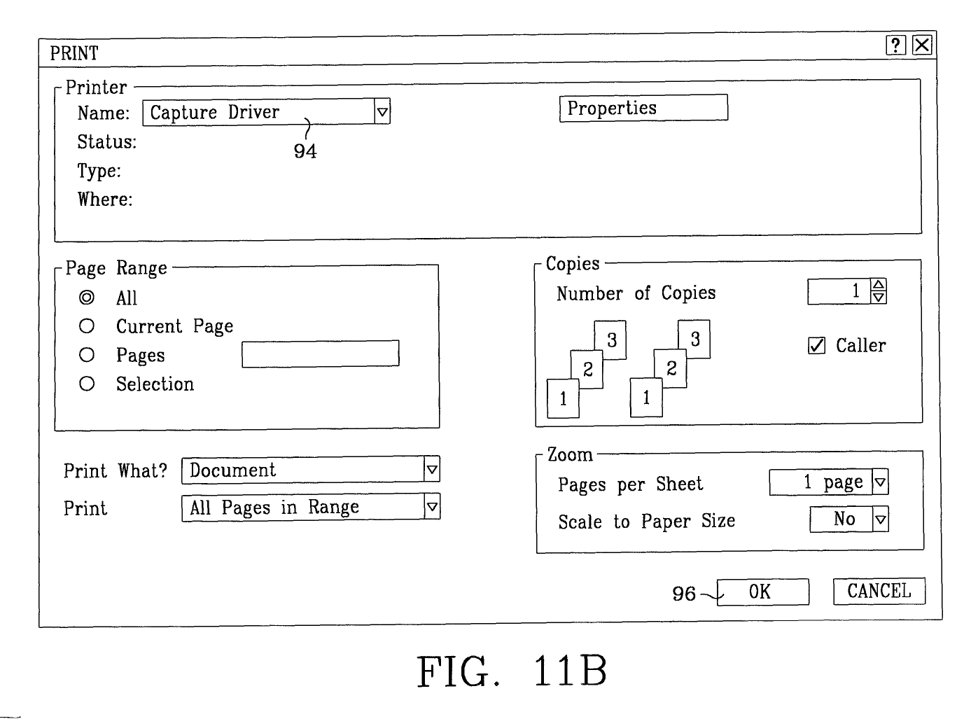

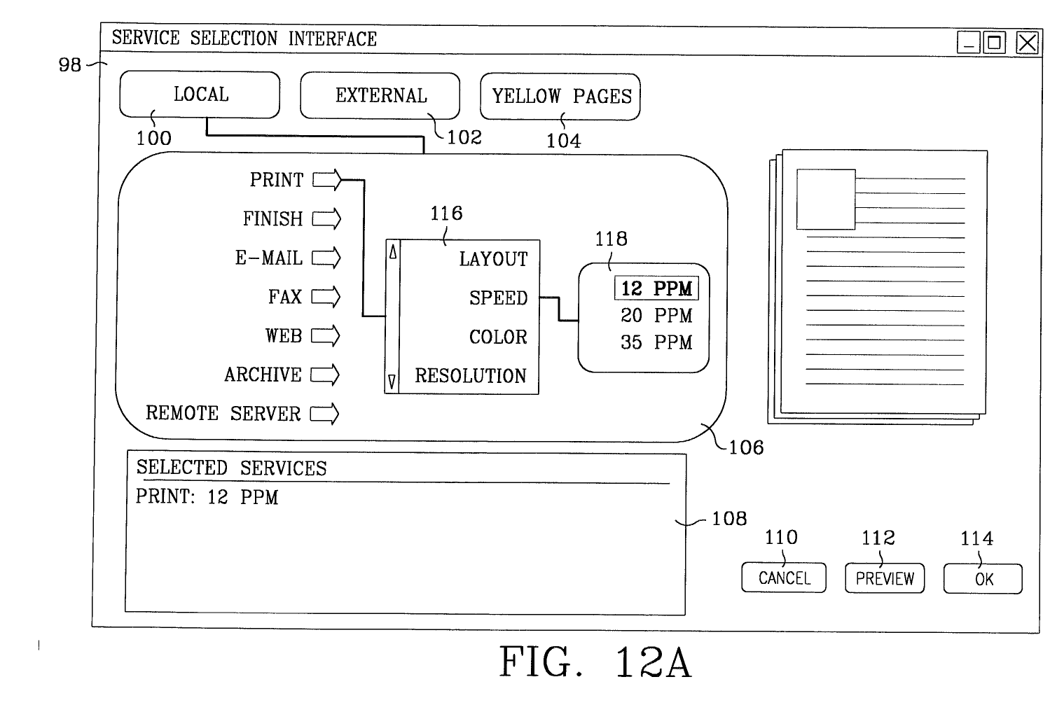

The use of the invented document production system will now be described with reference to the flow diagram FIG. 10 and the exemplary screen views of FIGS. 11-13. Beginning with FIG. 10, an electronic document is created or retrieved using application 28 (step 79). A print command is issued from within application 28 (step 80) and capture driver 34 is selected as the printer (step 81). Upon receipt of a production request from application 28, capture driver 34 translates the request into a selected generic format (step 82). Querying services database 38, services engine 40 identifies available services (step 83). As described above, those services need not be limited to those available on network 10, but may also include known services on external networks or other locations. Services engine 40, then, generates and interface translator 36 displays a user interface with user accessible controls for selecting services and option used for producing the production request (step 84). With the desired services and options selected, services engine 40, again querying services database 38, identifies one or more production devices 16 capable of providing the selected services and options (step 85), and generates a user interface with user accessible controls for selecting between the available devices (step 86). Production engine 40 merges the selected service with the formatted production request and generates production plan 44 (step 87) and delivers production plan 44 to the appropriate document production devices 16 (step 88).

It is envisioned that the document production process described above will be initiated through application 28. For example, with the desired document opened, a standard print command is issued. FIG. 11A illustrates a partial screen view of application 28 in which the “File” pull down menu 90 selected, the user selects print option 92. In response, application 28 generates print screen display 94 as shown in FIG. 11B. Here, using printer control 94, a user can select the destination for the production request. In this case “Capture Driver” is chosen. Selecting the “OK” control button 96 directs the production request to capture driver 34 of client 20.

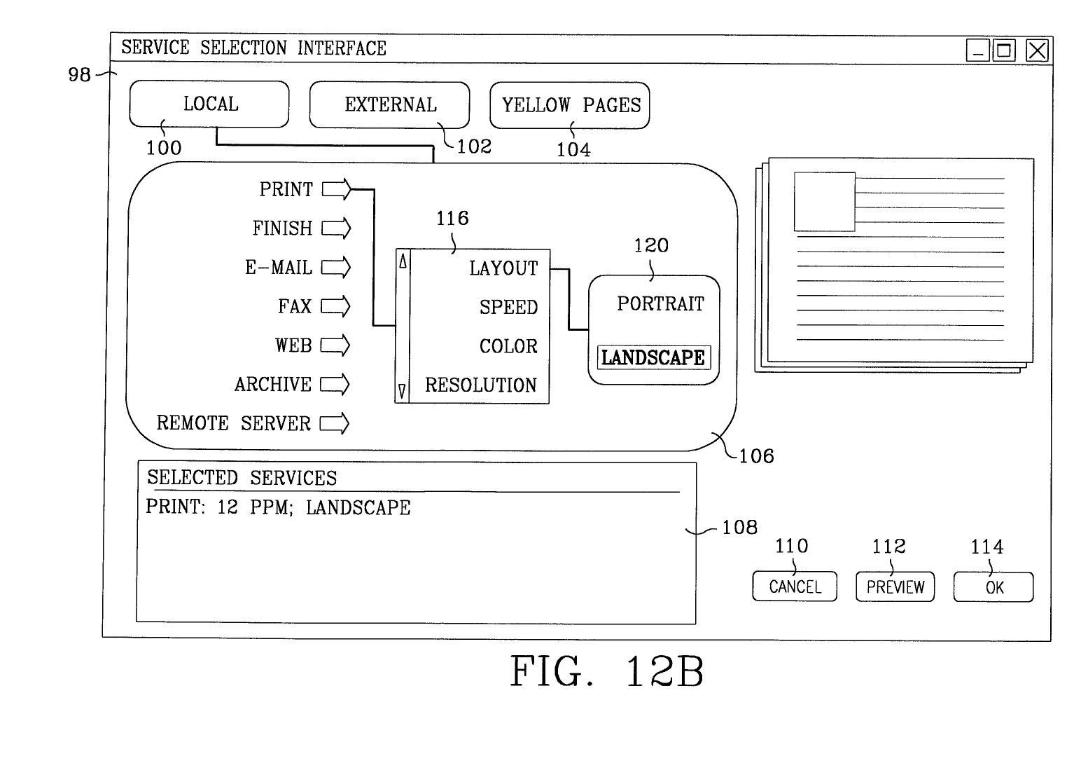

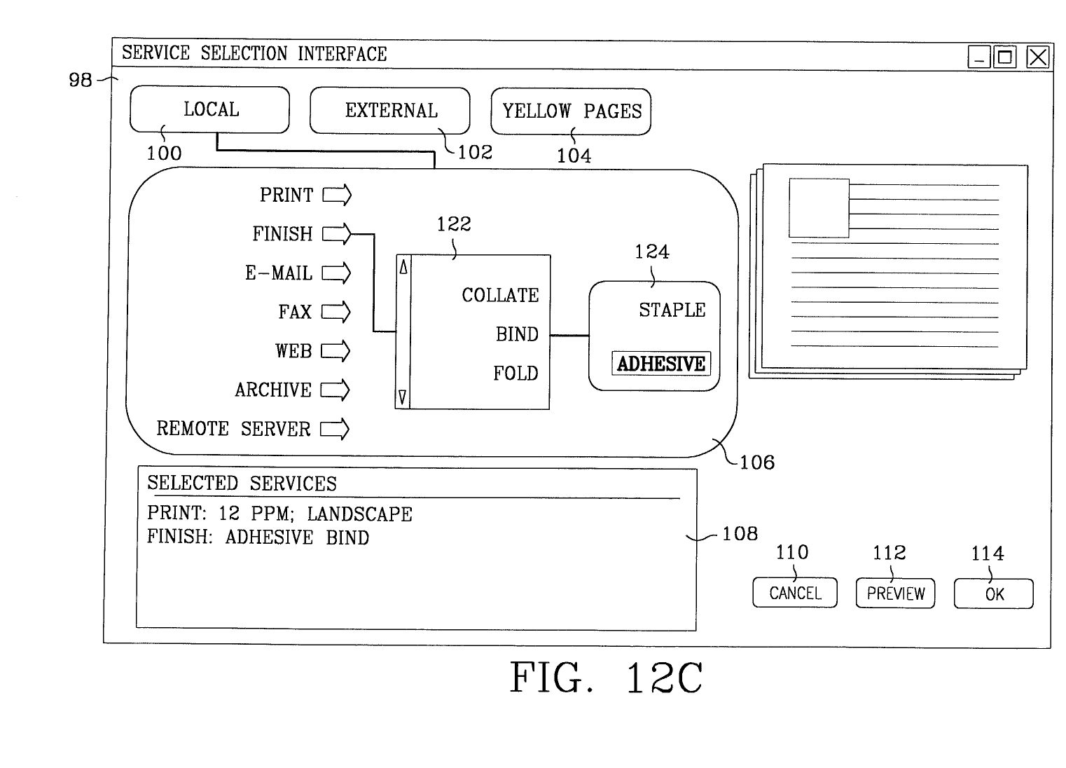

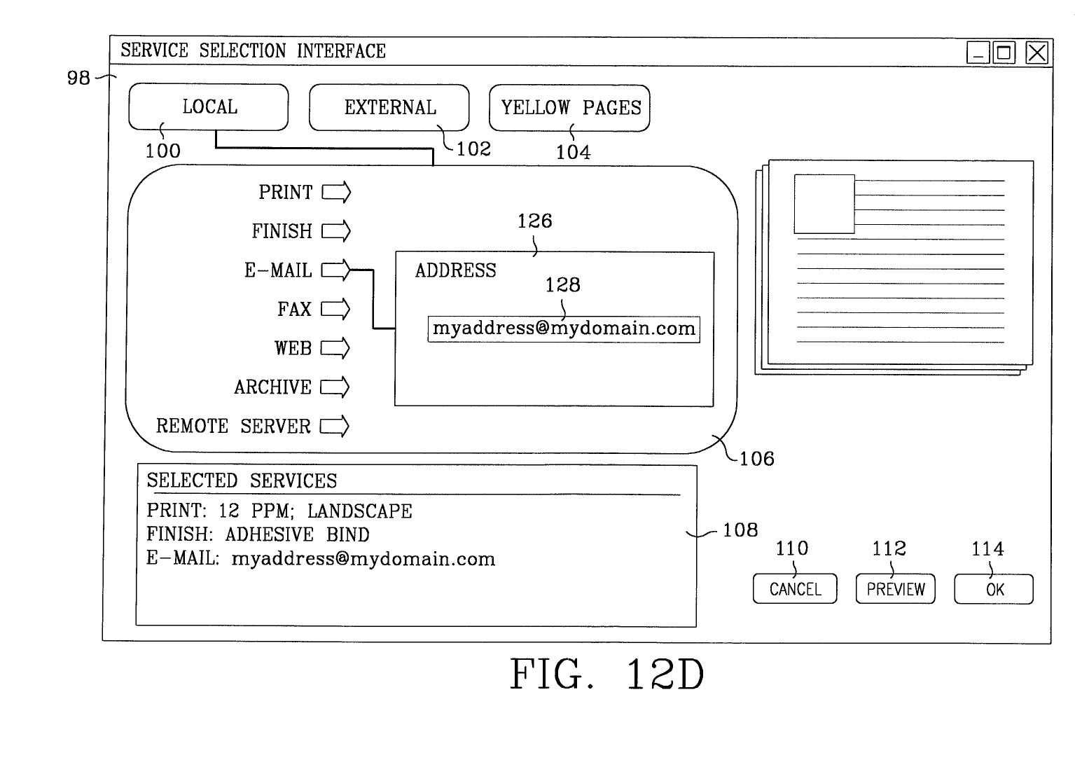

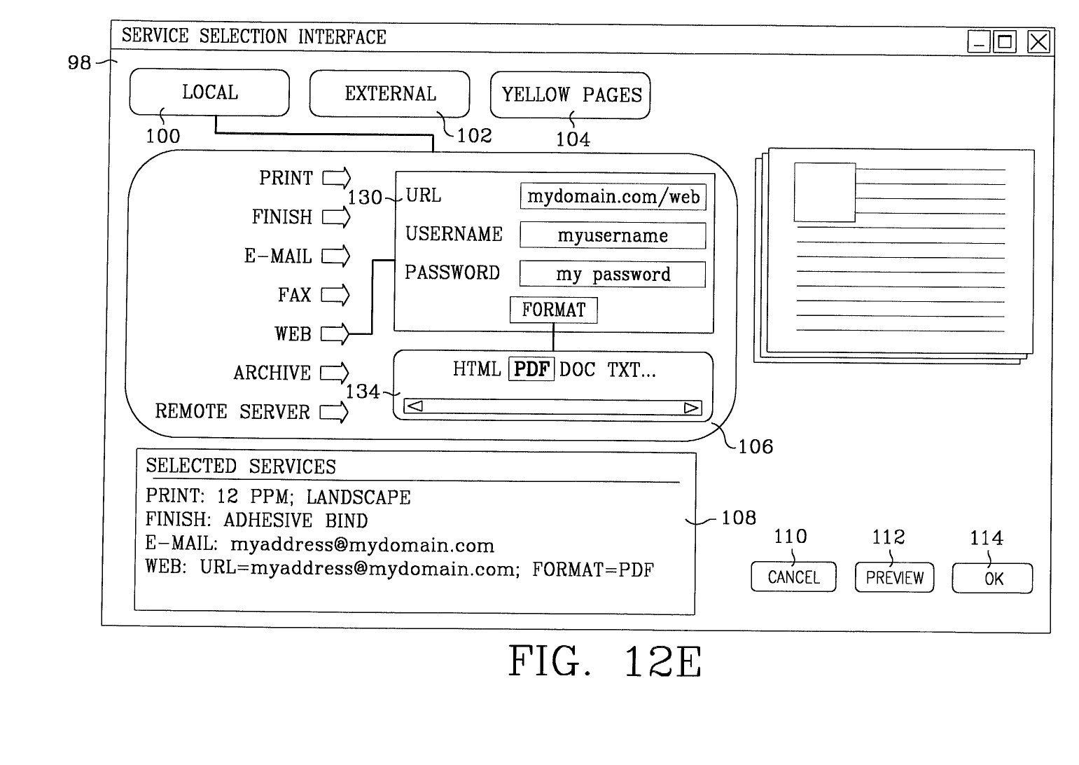

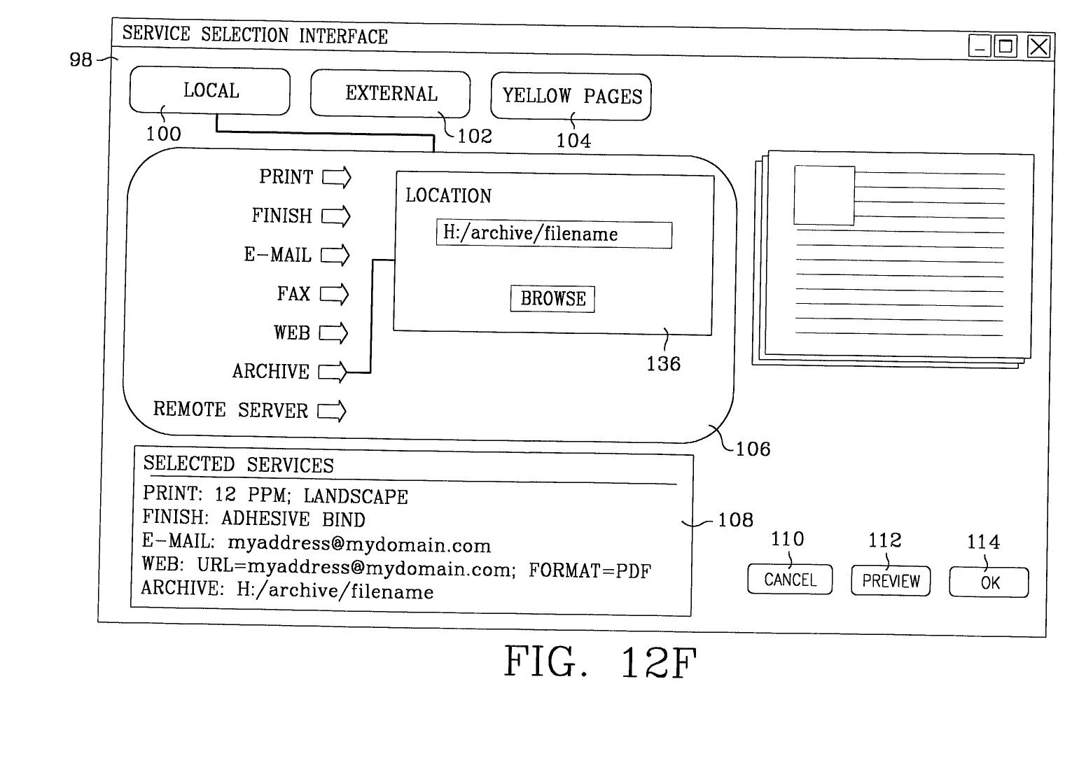

With the print request captured, interface translator 36 using data provided by interface generator 43 and service engine 40 produces a services selection interface 98 shown in the sequential screen displays illustrated in FIGS. 12A-12F. Interface 98 includes service location controls 100, 102, and 104, service selection control 106, selected services display 108, and command controls 110, 112, and 114. Interface 98 may also includes a preview pane providing a graphical representation of the document and services to be applied. In this example a user desires to produce a bound document in landscape format at a speed of at least twelve pages per minute. The user also desires to send a copy of the document via electronic mail. The document is to be also to be published to a web site in a particular format and finally stored in an archive.

Referring first to FIG. 12A, local service control 100 is selected causing service selection control 106 to display a list of services available on the local network. With “PRINT” service selected, print service control 116, containing a list of available print options, is displayed. The option “SPEED” is selected displaying a list 118 of available print speeds. Ultimately the speed 12 PPM or 12 pages per minute is selected. That setting is then reflected in selected services display 108. Next, as shown in FIG. 12B, the option “LAYOUT” is selected from print service control 116 displaying a list 120 of available layouts. The layout “LANDSCAPE” is selected, and the setting is reflected in selected services display 108. To bind the document, the “FINISH” service is selected displaying finish service control 122 containing a list of available finishing options as indicated in FIG. 12C. The option “BIND” is selected displaying a list 124 of available binding choices. “ADHESIVE” is selected and reflected in display 108.

In FIG. 12D, “E-MAIL” is chosen from services selection control 106. This displays e-mail control 126 allowing entry of address 128. Again, the setting is reflected in display 108. Referring to FIG. 12E, to publish the document on a web site, “WEB” is selected from services selection control 106 displaying web control 125. The URL (Uniform Resource Locator) of the desired location is entered along with credentials such as USER NAME and PASSWORD. “FORMAT” control 132 is selected displaying format list 134. “PDF” is chosen to publish the document in portable document format. To electronically store the document, “ARCHIVE” is selected from services selection control 106 as shown in FIG. 12F. Archive service control 136 is displayed allowing entry of a desired storage location.

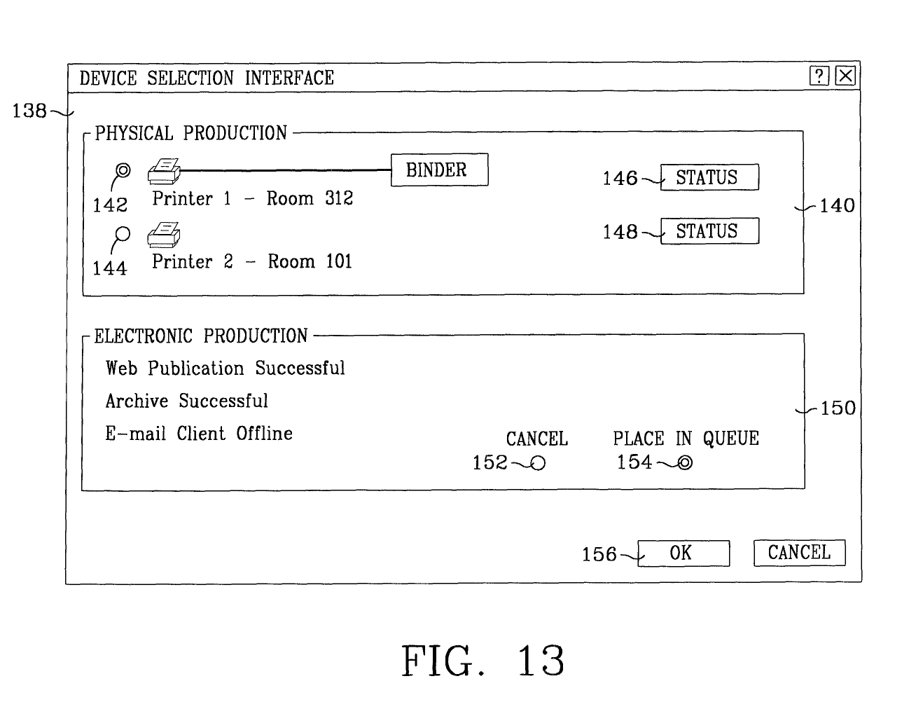

With all the desired services and options entered, “OK” command control 114 is selected. Services engine 40 then identifies devices for performing the selected services and service options and generates device selection interface 138, an example of which is illustrated in FIG. 13. Generally, interface 138 includes user accessible controls for selecting between the identified devices. Interface 138 may also include controls for determining the current status of the identified devices as well as controls for providing instruction on handing production plans directed to malfunctioning devices.

In the example of FIG. 13, interface 138 includes physical production control 140. Here, services engine 40 has located two printers. However, only one of those printers is connected to a finishing device capable of binding the document as desired. That combination is selected by default. If for some reason the user does not wish to use the default selection, interface 138 displays a second printer capable of producing an unbound document. Radio button controls 142 and 144 are placed next to the two selections allowing the user to select the desired printer. Status controls 146 and 148 allow the user to view the present status of the identified printers. Should the default selection be busy or malfunctioning, the user may choose print an unbound document using the alternate printer choice.

Interface 138 also includes electronic production control 150. Here, control 150 provides indication that the web publication and archive requests were successful. Control 150 also indicates that the e-mail service is off-line and presently unavailable. The user can select between two radio buttons 152 and 154 to either cancel the service or hold the e-mail request in a queue for later delivery. With the desired devices and other options chosen, “OK” command control 156 is selected allowing production engine 42 to deliver the production plan to the appropriate devices. Production engine 42 then monitors the production status of each of those devices.

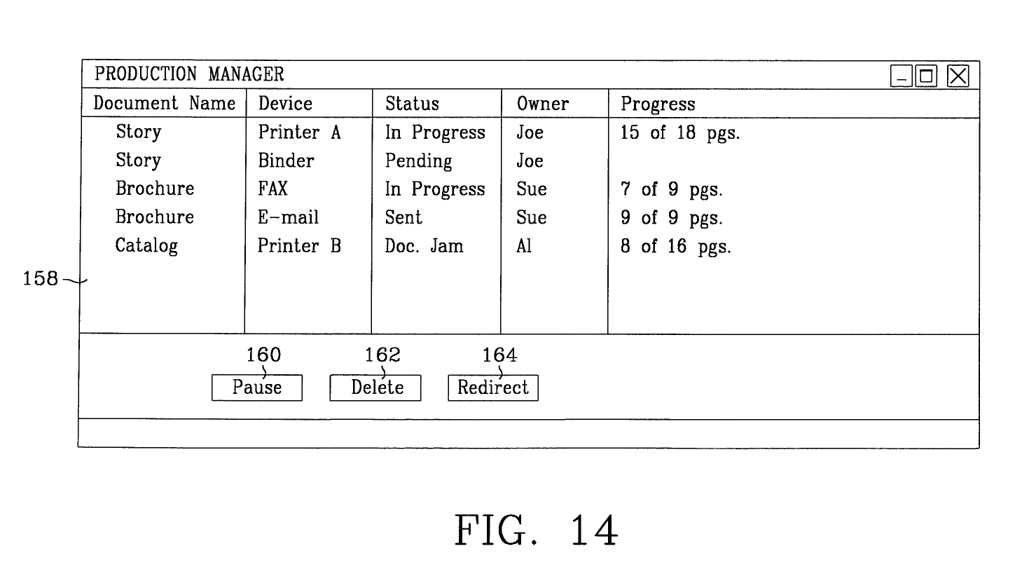

FIG. 14 illustrates production management interface 158 generated by production engine 42 and used for monitoring and managing document production plans. Interface 158 displays the status of each production plan generated by production engine 42 as well as user accessible controls for directing how production engine 42 manipulates those plans. In the example of FIG. 14, production management interface 158 displays the status of three plans—Story, Brochure, and Catalog. Story is to be produced on Printer A and then bound. Brochure is to be delivered via fax and electronic mail. Catalog is to be produced on Printer B. Interface 158 includes manipulation controls 160, 162, and 164 for controlling each plan. For example, interface 158 shows that Printer B is malfunctioning. Highlighting catalog and then selecting redirect control 164 allows the plan to be delivered to a functioning printer.

Although the flow chart of FIG. 10 shows a specific order of execution, the order of execution may differ from that which is depicted. For example, the order of execution of two or more blocks may be scrambled relative to the order shown. Also, two or more blocks shown in succession in FIG. 10 may be executed concurrently or with partial concurrence. All such variations are within the scope of the present invention.

The screen displays of FIGS. 11-14 are exemplary only. There exist many possible layout and control configurations for a user interface that will allow a user to select between available services and identified production devices. FIGS. 11-14 provide merely one example.

The present invention has been shown and described with reference to the foregoing exemplary embodiments. It is to be understood, however, that other forms, details, and embodiments may be made without departing from the spirit and scope of the invention which is defined in the following claims.

What is claimed is:

1. A method for managing electronic document production over a computer network, the method comprising:
on a first computing device, capturing a document production request and generating a user interface with user accessible controls for selecting services for producing the document; and
on a second computing device, merging selected services and the captured document production request into a document production plan and delivering the document production plan in a device specific format to one or more selected document production devices.

2. The method of claim 1, further comprising identifying services available on the network, and wherein the act of generating comprises generating a user interface with user accessible controls for selecting the identified services.

3. The method of claim 2, wherein the act of generating further comprises generating a user interface with user accessible controls for selecting services not available on the network.

4. The method of claim 2, wherein the act of identifying includes querying devices present on the network.

5. The method of claim 2, wherein the act of identifying includes querying a services database.

6. The method of claim 1, wherein the act of capturing includes receiving the document production request from an application and converting the production request into a generic format.

7. The method of claim 1, further comprising identifying document production devices capable of providing the selected services and generating a user interface with user accessible controls for selecting one or more, if any, of the identified document production devices.

8. The method of claim 1, further comprising monitoring the status of delivered document production plans.

9. A computer program product for managing electronic document production over a computer network, the product comprising a computer useable medium having computer readable instructions thereon for:
capturing a document production request on a first computing device;
generating a user interface with user accessible controls for selecting services for producing the document;
merging the selected services and the captured document production request into a document production plan; and
delivering the document production plan in a device specific format to one or more selected document production devices from a second computing device.

10. The product of claim 9, wherein the instructions for capturing comprise instructions for receiving a document production request from an application and transferring the production request to the second computing device.

11. The product of claim 9, comprising further instructions for identifying services available on the network, and the instructions for generating comprise instructions for generating a user interface with user accessible controls for selecting the identified services.

12. The product of claim 11, wherein the instructions for generating comprise further instructions for generating a user interface with user accessible controls for selecting the services not available on the network.

13. The product of claim 11, wherein the instructions for identifying comprise instructions for querying devices present on the network.

14. The product of claim 11, wherein the instructions for identifying comprise instructions for querying a services database.

15. The product of claim 14, comprising further instructions for identifying services available on the network but not contained in the service database and updating the services database with the identified services.

16. The product of claim 15, further comprising identifying services not available on the network and not contained in the services database and updating the services database with the identified services.

17. The product of claim 9, further comprising instructions for identifying document production devices capable of providing the selected services and generating a user interface with user accessible controls for selecting one or more, if any, of the identified document production devices.

18. The product of claim 9, further comprising instructions for monitoring the production status of delivered document production plans.

19. In a computer network, a system for managing document production requests, comprising:
a production client operable to receive a document production request, the client comprising a capture driver operable to capture the document production request and an interface translator operable to display user accessible controls for producing the document production request;
a production server in electronic communication with the client and operable to direct one or more selected devices to produce the captured document production request with selected services and options, the server comprising a services engine operable to inform the client of potential services and a production engine operable to deliver the captured document production request to the selected device or devices.

20. The system of claim 19, wherein the capture driver is further operable to transform the document production request into a selected format and to transfer the formatted document production request to the production server.

21. The system of claim 19, wherein the server further comprises a web server for communicating with the client and the client interface translator is a web browser.

22. The system of claim 21, wherein the services engine includes a services locator operable to identify services available on the network.

23. The system of claim 21, wherein the production server further comprises a database of known services available on the network.

24. The system of claim 23, wherein the services locator is operable to identify available services by querying the database and by querying the document production devices present on the network.

25. The system of claim 19, wherein the services engine further includes a device identifier operable to identify one or more, if any, available document production devices that are compatible with the selected services and options and to provide the interface translator with information required to display user accessible controls for selecting one or more, if any, of the identified document production devices.

26. The system of claim 19, wherein the production engine includes a production queue.

27. The system of claim 26, wherein the production engine further includes a production manager in electronic communication with the production queue.

28. The system of claim 19, wherein the Client further comprises a server locator.

29. A distributed document production system comprising:
one or more document production devices;
a production client operating on a first computing device;
a production server operating on a second computing device, the production server in electronic communication with the production client and the document production devices, the production server operable to receive a production request from the production client and to deliver the request to one or more selected production devices in a device specific format.

30. The document production system of claim 29, wherein the production client comprises a capture driver operable to electronically transfer a document production request to the production server and an interface translator operable to display user accessible controls for selecting services for producing the document.

31. The document production system of claim 30, wherein the capture driver is further operable to transform the document production request into a generic format and to transfer the formatted document production request to the production server.

32. The document production system of claim 29, wherein the production server comprises a services engine operable to inform the production client of potential services and a production engine operable to deliver the document production request with selected services to one or more of the document production devices.

33. The document production system of claim 32, wherein the interface translator is a web browser and the production server further comprises a web server for communicating with the interface translator.

34. The document production system of claim 32, further comprising a services database and wherein the services engine includes a services locator operable to locate services by querying the services database.

35. The document production system of claim 34, wherein the production services locator is further operable to locate services by querying the document production devices.

36. The document production system of claim 34, wherein the production server further includes an update service operable to update the services database with services available on the document production devices but not currently represented in the services database

37. The document production system of claim 36, wherein the production engine includes drivers for the production devices and wherein the update service is further operable identify new devices and to update the device drivers with drivers for newly identified devices.

38. The document production system of claim 32, wherein the services engine further includes a device identifier operable to identify one or more, if any, of the document production devices that are compatible with the selected services, and wherein the production engine is operable to supply the interface generator with information to display user accessible controls for selecting one or more, if any, of the identified document production devices.

39. The document production system of claim 32, wherein the production engine includes a production queue and a production manager in electronic communication with the production queue.

40. The system of claim 30, wherein the production client further comprises a server locator.
